(19) United States
(12) Patent Application Publication
(10) Pub. No.: US 2010/0312778 A1
(43) Pub. Date: Dec. 9, 2010

(54) PREDICTIVE PERSON NAME VARIANTS FOR WEB SEARCH

(76) Inventors: Yumao LU, San Jose, CA (US); Fuchun PENG, Sunnyvale, CA (US); Benoit DUMOULIN, Palo Alto, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/480,628

(22) Filed: Jun. 8, 2009

(51) Int. Cl. G06F 17/30

(52) U.S. Cl. 707/759; 707/736; 707/769; 707/713

(57) ABSTRACT

Techniques for determining when and which name variant candidates to use to re-write a search query that includes a person's name in order to provide the most relevant search results are provided. A determination is made whether a person name is present in a search query request entered by a user. Name variant candidates are generated for each person name. Then, the name variant candidates are ranked for each person name based upon one or more models that calculate a probability value for each name variant candidate. Based upon these rankings, the query may be re-written to include the original person name and a specified number of top ranked name variant candidates to present the user with the most relevant search results.

### FIELD OF THE INVENTION

The present invention relates generally to search engines.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

A search engine is a computer application program that helps a user to locate information. Using a search engine, a user may enter one or more search query terms and obtain a list of resources that contain or are associated with subject matter that matches those search query terms. While search engines may be applied in a variety of contexts, search engines are especially useful for locating resources that are accessible through the Internet. Resources that may be located through a search engine include, for example, files whose content is composed in a page description language such as Hypertext Markup Language (HTML). Such files are typically called pages. One can use a search engine to generate a list of Universal Resource Locators (URLs) and/or HTML links to files, or pages, that are likely to be of interest.

Search engines order a list of files before presenting the list to a user. To order a list of files, a search engine may assign a rank to each file in the list. When the list is sorted by rank, a file with a relatively higher rank may be placed closer to the head of the list than a file with a relatively lower rank. The user, when presented with the sorted list, sees the most highly ranked files first. To aid the user in his search, a search engine may rank the files according to relevance. Relevance is a measure of how closely the subject matter of the file matches query terms and/or the intent of the user.

To find the most relevant files, search engines typically try to select, from among a plurality of files, files that include many or all of the words that a user entered into a search request. Unfortunately, the files that a user may be most interested are too often files that do not exactly match the words that the user entered into the search request. This may occur frequently when a user enters a person's name as part of a search query. If the user enters a particular name in the search request, such as “Bill,” then the search engine may fail to select files in which other variants of the name occurs. For example, the name “Bill” is different from the variant name “William.” Thus, entering the search term “Bill” might preclude web documents that contain the word “William” but not the term “Bill.” As a result, the search engine may return sub-optimal results for the particular query.

In addition, using a particular name variant for a person's name may or may not be useful in search results. There may be some instances where using a name variant for a person's name may improve the relevance of a search result, but other instances where use of the name variant decreases the relevance and precision of a search result. Thus, there is a need for techniques to determine when and which particular name variants to use in a query in order to provide the most relevant search results.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram displaying an overview of session based query analysis, according to an embodiment of the invention;

FIG. 2 is a flow diagram displaying an overview of determining when and which name variant candidates to use to re-write a search query that includes a person's name, according to an embodiment of the invention; and

FIG. 3 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

English given names often have multiple common nicknames. A nickname is “a name added to or substituted for the proper name of a person, place, etc., as in affection, ridicule, or familiarity.” (Dictionary.com, available at http://dictionary.reference.com/browse/nickname, last visited Jun. 4, 2009). For example, people with the given name “William” might also have the nicknames “Bill,” “Billy,” “Willie,” or even “Bubba.” A common nickname may also have multiple corresponding formal names. For example, the nickname “Bill” might correspond to any of the formal names “William,” “Wilfred,” “Guillaume,” “Guillermo,” or “Wilhelm.” Thus, a single nickname may have multiple common formal names and one formal name may have multiple common nick names. The relationship is called a many-to-many mapping.

In search queries submitted to search engines, users may include person names within a search query. However, the search engine may not be able to locate resources that only contain content that include a name variant of the person name entered by the user. For example, a user might enter the name “Bill Clinton” to find additional information about the former United States president. Some resources may refer to the president only as “William” Clinton. The resources that refer to the president only as “William” may appear less relevant to the search engine because fewer query terms match the terms in the resource and so would appear further down in the search query results or not at all. Thus, by re-writing the query such that name variants are included with the person name, search results may be improved.

Lists of name variant candidates may be generated from previous user queries or existing lists of name variants. Adding name variants in a search query may often return more relevant search results. However, including all known name variants in a re-written query indiscriminately may cause search results that are less relevant and have less precision. For example, a user might enter the search query “Prince Bill” to find resources that relate to Prince William, heir to the throne in the United Kingdom. “Bill” as discussed above, might correspond to any of the formal names “William,” “Wilfred,” “Guillaume,” “Guillermo,” or “Wilhelm.” If all of the names were included in the re-written query, then resources also might be returned for “Prince Wilhelm,” the Crown Prince of Germany during World War I. By including results for the German prince, the search results returned are less precise and less relevant to the user.

A determination is made of which name variant candidates to include in the re-written query. Probabilities may be calculated for each name based on one or more methods to determine the most likely name variant candidates to replace or include with the original person name included in the search query. Rankings may then be determined for each name variant candidate of the person name. The highest ranked name variants may then be used to re-write the query for execution by the search engine.

The results of the executed search query are presented to the user. Based on how the query was re-written, the results presented to the user may vary. For example, the query might be re-written such that name variants are used to affect only the presentation of the search results to the user, but not the resources retrieved. Queries may also be re-written such that resources are gathered based upon the name variant candidates used.

### Determine Whether Person Name is Present in Search Query

Once a search query request is submitted by the user, a determination is made of whether one or more person names are present in the search query request. Numerous models may be used to determine that a person's name is included in the search query request and the actual model employed may vary from implementation to implementation.

In an embodiment, a Conditional Random Field (“CRF”) model is used to recognize person names in user queries. CRF is a discriminative probabilistic model that may be used to label sequential data. In an embodiment, the CRF model is trained using a pre-tagged corpus of search queries. For example, a CRF engine might be given 250,000 different previously submitted search queries. The CRF engine tags each term of the search query with a label of whether the term is a person name. An example of such a tagged search query might be:

Search query: “bill clinton president”

The first term (Ta) is “bill,” the second term (Tb) is “clinton,” and the third term (Tc) is “president.” Each term of the search query is labeled: “Ta” might be labeled “Beg-PER” as the beginning of person name, “Tb” might be labeled “End-PER” as the end of the person name, and “Tc” might be labeled “0” as not containing any person name. Through training, the CRF model is able to label newly submitted untagged search queries and accurately determine whether a particular term in a search query is a person name. Additional training may be performed or additional rules added in order to increase the precision and recall of the CRF model.

In another embodiment, a Hidden Markov Model (HMM) is employed to determine the presence of person names within a search query. HMM is a statistical model that has been used to find the part-of-speech of a given word. For example, an article such as “the” might indicate that the next word is a noun 40% of the time, an adjective 40% of the time, and a number 20% of the time. Based on these probabilities, the part of speech of the next word is determined. This model may be easily adapted for use to also find the presence of person names. A Support Vector Machine (SVM) model or a hybrid of HMM and SVM may also be used to determine the presence of person names in search queries. SVMs are related supervised learning methods used for classification and regression. In SVM, given data (a corpus) that belong to one of two classes (‘name’ or ‘not a name’) is analyzed. When a new data point (word) is received, a determination is made as to which class the new data point belongs. In addition, any other model that labels and classifies data that may be adapted to find person names may also be used.

### Obtain Name Variants and Dictionary Generation

Once a person name is identified in a particular search query, possible name variant candidates are considered. All possible name variant candidates for the identified person name in the query are retrieved. In an embodiment, possible name variant candidates are stored in two different dictionaries: 1) a nickname to formal name dictionary and 2) a formal name to nickname dictionary. These dictionaries may have been generated offline previous to receiving any search query. An example of two entries in a nickname to formal name dictionary might appear as:

| | |
|---|---|
| Al | Alan, Alvin, Albert, Alexander, Alex, Alexander, |
| | Alonzo, Alfred, Alistair, Alejandro |
| Bill | William, Wilhelm, Wilfred, Guillaume, Guillermo, |
| | Wildon, Wilson, Willy, Wilbur |

The name variants in the dictionary may be from existing dictionaries or may be generated based upon previous search queries received or an existing Web corpus. Name variants may also be derived from the lists of names maintained by the Social Security Administration. Administrators of the name variant candidate database may also enter names that may not be common (city names used as names, “Brooklyn” or “Bronx”), or have relatively unusual spellings (the uncommon “Ahtum” for the more routinely spelled “Autumn”).

In an embodiment, entries for nicknames in a dictionary are not limited to familiar forms of a proper name (“Bill” to “William”). Nicknames might refer to a person's characteristics and have little to do with their proper name (“Magic” for the professional basketball player, “Earvin Johnson”; “the Body” for spokesperson and model “Heidi Klum”). Nicknames might also refer to names developed in popular culture gossip periodicals (“Brangelina” to refer to “Brad Pitt and Angelina Jolie” and “Octomom” to mother of octuplets, “Nadya Suleman”).

### Determine the Highest Ranked Name Variant Candidates

Many different models may also be used to rank the name variant candidates for each person name. Any type of algorithm capable of determining rank or relevance may be used to rank the name variant candidates. Though the specific models of using white page frequency, a statistical translation model, and session based query analysis are discussed herein, determining the highest ranked name variant candidates to use is in no way limited to these models.

In white page frequency, the frequency or occurrence of name variant candidates are counted in a known list of names. For example, a list of names from the Social Security Administration may be used to find the popularity of names of people in the United States for a given year. Using the lists of names from the Social Security Administration, counts or popularity of name variant candidates are calculated. The name variant candidates are ranked based upon the popularity of use and the highest ranked name variant candidates are those names that are the most popular.

A statistical translation model may be used to calculate the probabilities of finding a name variant candidate where the person name is found in a resource. This model calculates and stores the probabilities, given a corpus or web files, of the number of times any word sequence occurs within the corpus. The corpus may be the entire Internet, a set of previous search queries, or a small collection of files on a single web server. In an example, a notation of the probability of the occurrence of a four word phrase “w₁w₂w₃w₄” is “P(w₁w₂w₃w₄)” and might be shown as follows:

$$\begin{matrix}P ( {w}_{1} {w}_{2} {w}_{3} {w}_{4} ) = \frac{\# ( {w}_{1} {w}_{2} {w}_{3} {w}_{4} )}{\sum {(}^{*} )} \\ = P ( {w}_{1} ) \cdot P ( {w}_{2} \vert {w}_{1} ) \cdot P ( {w}_{3} \vert {w}_{2} {w}_{1} ) \cdot P ( {w}_{4} \vert {w}_{3} {w}_{2} {w}_{1} )\end{matrix}$$

In the example, the four word phrase is “w₁w₂w₃w₄,” with each “wₙ” representing the n^{th} word. P(w₁w₂w₃w₄) is equal to the number of times the phrase, “w₁w₂w₃w₄,” appears within the corpus “*.” The notation may also be expanded to P(w₁)·P(w₂|w₁)·P(w₃|w₁w₂)·P(w₄|w₁w₂w₃). As an example, P(w₂|w₁) is the probability of the occurrence of w₂ in resources that contain w₂. A formula with this notation might be shown as:

$$P ( {w}_{4} \vert {w}_{1} {w}_{2} {w}_{3} ) = \frac{\# ( {w}_{1} {w}_{2} {w}_{3} {w}_{4} )}{\# ( {w}_{1} {w}_{2} {w}_{3} )}$$

P(w₄|w₁w₂w₃) returns the frequency of occurrences of the phrase, “w₁w₂w₃w₄,” in resources that also contain the phrase, “w₁w₂w₃” within the given corpus.

Rather than performing a full calculation based on all words in the phrase as P(w₄|w₁w₂w₃) shows, N-gram models may be employed. In N-gram models, not all words of the phrase are used to calculate the frequency of occurrences. For example, in a tri-gram model, such as P(w₄|w₂w₃), the word phrase, “w₂w₃w₄,” is counted in resources that also contain the two preceding words, “w₂w₃”. In a bi-gram model, the word phrase, “w₃w₄,” is counted in files that also contain the preceding word, “w₃”. This is represented as P(w₄|w₃). Each N-gram increases overhead as the value of N increases.

By determining the number of times a name variant candidate appears within the corpus and within the context of the other terms in the search query, a probability value may be determined for each name variant candidate and rankings determined from those probability values.

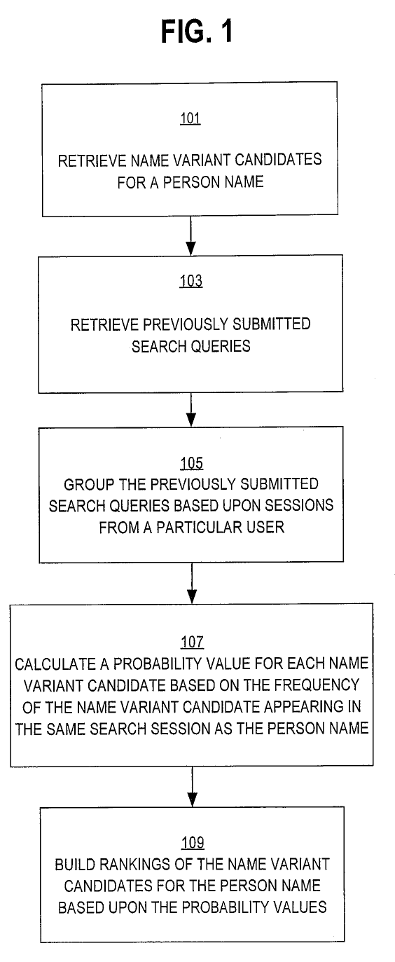

Another model that may be used is session based query analysis. Session based query analysis considers search behavior of a particular user within a session, or certain time constraint. This model is illustrated in FIG. 1. First, a server retrieves all of the different name variant candidates for a particular person name, as shown in 101. Then, as shown in 103, previous queries submitted by users are compiled and gathered by the server. The previous queries may be extracted from cookies that are stored on a user's computer. Alternatively, the previous queries may be stored on a central database when the search queries are received. Any identification data of a user may be removed from the cookies in order to preserve the privacy of the user. The queries are grouped based upon a session from a user, as shown in 105. Sessions may be defined as being within a specified time boundary. The specified time boundary may be, for example, thirty minutes, but may vary from implementation to implementation. In another embodiment, a session may be based on express login/logout actions performed by the user.

By viewing queries submitted by the same user within a session, a better sense of user intent and actual name variant user may be determined. This model is detailed through the following example. A user might be searching for a specific resource about “president William Clinton” and submits the search query “president William Clinton.” The user views the results and might visit some of the resources that are returned, but discovers that he has not yet found the resource sought. Thus, the user tries to refine his search query. In the next search submitted, the user submits the search query “president Bill Clinton” trying to find the resource. Here too, the user still has not found the resource sought. Then, the user reconsiders and enters the search query “president bubba Clinton.” Results are returned and the user finally does find the resource with the third search and ends his search at that point.

The three search queries were submitted in the same session even though the search queries were not submitted immediately after each other (the user visited some resource results) as the search queries occurred within the specified time period of the session. Even if other search queries were submitted between the search queries for President Clinton, the analysis is still relevant because the search queries were submitted in the same session. By analyzing the search queries submitted in this session, the name variant candidates of “Bill” and “Bubba” would be counted as appearing in the same session as the person name “William.” This analysis is then applied to thousands or millions of different sessions to discover patterns and calculate probabilities for actual name variant usage with the original person name.

The probability of a name variant candidate appearing in a same session that also contains the original query is calculated by analyzing all sessions gathered, as shown in 107. This ensures that the name variant candidate is found in the same context as the original person name.

In an embodiment, session based query analysis may be represented by the notation P(N′₁|N₁)=#N₁N′₁. For example, if the original person name, N₁, is “William” and the name variant candidate, N′₁, is “Bill,” then the number of occurrences of “Bill” in a search session is determined where the search session also contains the original name “William.” Thus, a probability may be determined of a particular name variant candidate with respect to a person name.

Session based query analysis may be enhanced by employing weighted averages. For example, the first and the last search query from the example with a single user may be given more weight because, presumably, the last search query returns the results sought by the user (as no more search queries are submitted) and the first search provides an indication of the initial intent of the user.

By analyzing similar data across millions of search sessions, an analyzer may determine name variant candidate rankings for each person name based upon the probability values calculated, as shown in 109. Session based query analysis rankings may be updated at specified time intervals or through continuous real-time updating. Updating after the initial process may occur monthly, quarterly, or in any other period of time that is deemed necessary. Updating rankings at specified time intervals saves computer resources by limiting the amount of time that servers process search query data, but the rankings may fluctuate quickly. However, by analyzing search query session data continuously, an analyzer may take into account a large news story that may affect rankings in only one day. The news story may be reflected in more accurate re-written queries at the cost of much greater use of computational resources.

A combination of two or more models may also be employed to determine the most probable name variants. For example, white page analysis and the statistical translational model results might be combined to provide more accurate results. White page analysis, statistical translation model, and the session based search query analysis might also be combined to determine the most probable name variants. The combinations may be considered in a number of different ways. Results from each model may be given a numerical value. These numerical values may be weighted equally for each model. In another embodiment, the numerical values may be weighted unequally, with one model being given a higher weight than another model.

In an embodiment, rankings may be calculated offline, previous to receiving any search query from the user in order to use computational resources more efficiently. In another embodiment, to calculate the most accurate rankings, a calculator may calculate rankings in real time upon receiving the search query, but at the cost of extensive use of computational resources.

### Query Re-Writing

After a person name is found and the name variant candidates compiled, a top specified number of name variant candidates may be used to rewrite the query. The top specified number of name variant candidates may be different depending upon whether the person name is a formal name to nickname mapping or a nickname to formal name mapping. The top specified number may also vary depending upon the person name. For example, name variant candidates might be given a numerical score when determining the rankings of the name variant candidates. A threshold value may be specified to trigger use of the name variant candidate if the name variant candidate has a numerical score that satisfies the threshold value. Some formal names might have five difference name variant candidates that satisfy the threshold value and hence, all five name variant candidates might be used. Other formal names might have one or no name variant candidates that satisfy the threshold value and thus, only a single or no name variant candidates may be used. In an embodiment, a number may be specified as the maximum number of name variant candidates to be used for a re-written query. An administrator may vary the specified number based upon previous search results analyzed.

In an embodiment, user-received search queries found to contain a person name are re-written using the specified number of top name variant candidates. In an embodiment, name variant candidates may be treated equivalently with the original person name in ranking search results or in presentation of results. For example, the query execution driver (QED) operator “equiv” might indicate to the server that a person name and a name variant candidate are to be treated equally. This might be shown as:

equiv {<A><A′>}

This notation indicates that the name variant “A′” is to be treated equivalently as the person name “A.”

In another embodiment, name variants might be assigned a particular weighting within the search query. Under this circumstance, name variants are tagged as a “name variant” and assigned a specified weighting within the re-written search query. The weighting may be greater or less than the original person name submitted in the search. The weighting may be dynamically assigned based upon the numerical values calculated when determining the top ranked name variant candidates. The weighting may also be a specified set value. In this latter case, this may ensure that the original person name submitted by the user will be given more weight by the search engine and always considered.

In an embodiment, a re-written query always includes the person name submitted in the original query. In other embodiments, the re-written query does not necessarily need to include the original person name submitted but may be replaced entirely with name variants.

In an embodiment, the query may be re-written such that only the presentation of results is affected and not the resources that are returned. Under this circumstance, the original search query is used by the search engine to gather the resources for presentation to the user. In an embodiment, when the search engine ranks the resources gathered for presentation, the search engine may consider both the person name and the name variants. In another embodiment, the search engine may only consider the original person name when ranking the results for presentation. Most search engines also display a snippet of text from the resource as part of the results shown to the user with terms in the search query bolded. The re-written query may specify whether or not to display snippets of text from the resource that also include the name variant and whether or not to display the name variant in bold.

In another embodiment, the query may be re-written such that both the presentation of results and the resources returned do consider name variants. This affects the resources found by the search engine, and the ranking and presentation of the results to the user.

### Illustrated Overview

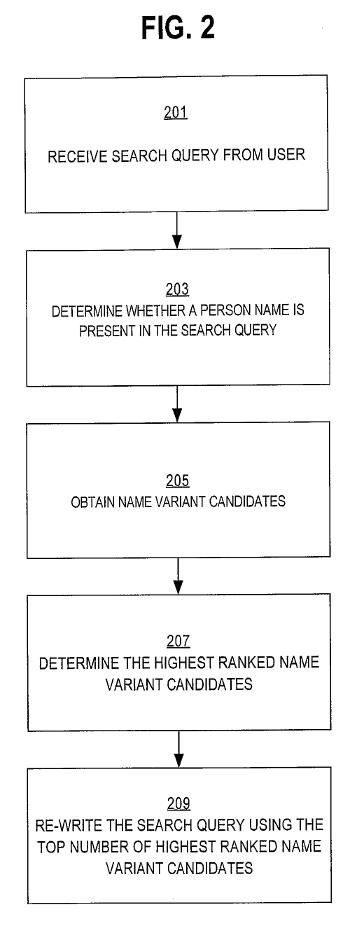

Determining when and how to use a name variant to a search query is important to obtain the most relevant search results with minimal overhead. FIG. 2 is a block diagram displaying an overview of an embodiment of this technique. First, a query is received from the user, as shown in 201. Then, a server determines whether a person's name is present in the search query received, as shown in 203. The presence of a name may be found, for example, by the CRF model. In step 205, the server obtains name variant candidates from dictionaries that may have been previously generated offline. The highest ranked name variant candidates are then determined, as shown in step 207. The calculations to determine these rankings may be performed offline prior to receiving any search query or in real time. The ranking may be determined using, for example, the white page frequency, the statistical translation model, or the session based search query analysis model. A combination of two or more of these models may also be used to determine the rankings. Once the name variant candidates are ranked, the search query is re-written using a specified number of the top ranked name variant candidates, as shown in step 209. The query may be re-written such that only the presentation of results to the user is affected. The query may also be re-written such that resource retrieval and the presentation of results are affected.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

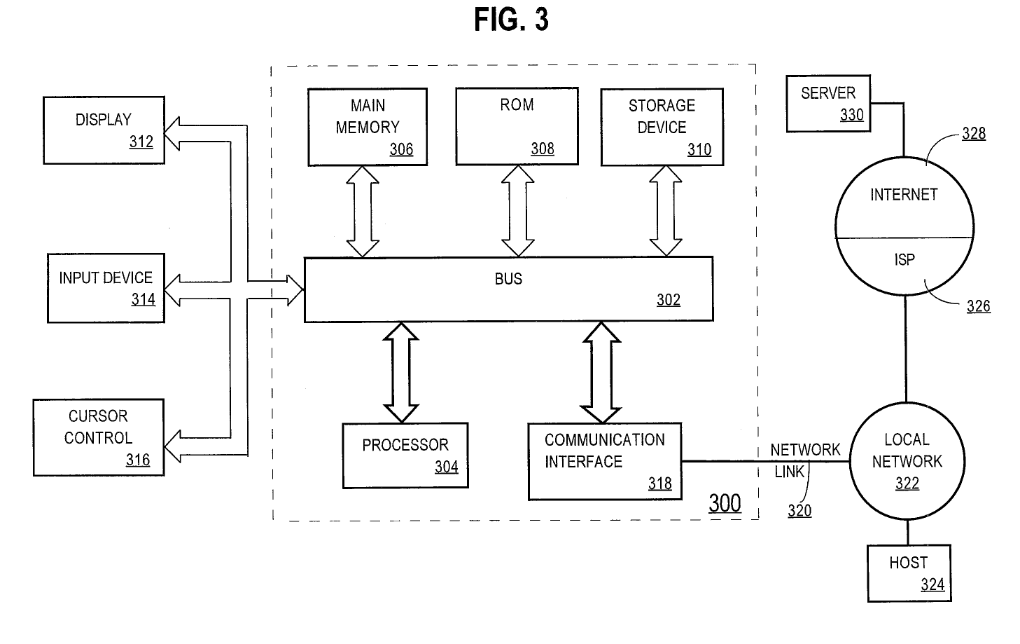

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method, comprising:
receiving a particular query from a user;
determining whether the particular query contains at least one name;
upon determining that the particular query contains at least one name, obtaining name variant candidates for the at least one name;
determining highest ranked name variants of the name variant candidates for the at least one name based at least in part on one or more of: a) analyzing white page frequency, b) using a statistical translation model, and c) analyzing a corpus of previously received search queries delimited by session;
re-writing the particular query using the highest ranked name variants; and
generating results based on executing the re-written query,
wherein the method is performed by one or more computing devices.

2. The method of claim 1, wherein determining whether the particular query contains at least one name is based on using a conditional random fields model.

3. The method of claim 1, wherein determining whether the particular query contains at least one name is based on using a support vector machine model.

4. The method of claim 1, wherein re-writing the particular query changes presentation of the results, but not rankings of the results.

5. The method of claim 1, wherein re-writing the particular query includes the at least one name in the particular query in the re-written query.

6. A method, comprising:
generating a plurality of name variant candidates for a particular name;
compiling session data of previous search queries that indicate queries sent within a single session of a user;
calculating a probability value of each name variant candidate of the plurality of name variant candidates based at least in part on the frequency that a name variant candidate appears with the particular name in a single session of search queries; and
building rankings of the name variant candidates with respect to the particular name based on the probability values determined,
wherein the method is performed by one or more computing devices.

7. The method of claim 6, wherein a single session is within a specified time period.

8. One or more storage media storing instructions which, when executed by one or more computing devices, cause performance of the method recited in claim 1.

9. One or more storage media storing instructions which, when executed by one or more computing devices, cause performance of the method recited in claim 2.

10. One or more storage media storing instructions which, when executed by one or more computing devices, cause performance of the method recited in claim 3.

11. One or more storage media storing instructions which, when executed by one or more computing devices, cause performance of the method recited in claim 4.

12. One or more storage media storing instructions which, when executed by one or more computing devices, cause performance of the method recited in claim 5.

13. One or more storage media storing instructions which, when executed by one or more computing devices, cause performance of the method recited in claim 6.

14. One or more storage media storing instructions which, when executed by one or more computing devices, cause performance of the method recited in claim 7.
